(19) United States
(12) Patent Application Publication
(10) Pub. No.: US 2026/0219211 A1
(43) Pub. Date: Jul. 30, 2026

(54) X-RAY DIFFERENTIAL PHASE CONTRAST NANO CT SYSTEM AND IMAGING METHOD THEREFOR

(71) Applicant: Jinan Hanjiang Optoelectronic Technology Co., Ltd, Jinan (CN)

(72) Inventors: Keliang LIAO, Jinan (CN); Peiping ZHU, Jinan (CN)

(21) Appl. No.: 19/135,695

(22) PCT Filed: Aug. 18, 2023
(86) PCT No.: PCT/CN2023/113785

§ 371 Date: Jun. 4, 2025

(30) Foreign Application Priority Data
Dec. 5, 2022 (CN) 202211547118.7

(51) Int. Cl. G01N 23/046

(52) U.S. Cl. CPC G01N 23/046; G01N 2223/05; G01N 2223/1016; G01N 2223/419

(57) ABSTRACT

Disclosed are an X-ray differential phase contrast nano CT system and an imaging method therefor. The X-ray differential phase contrast nano CT system mainly comprises: an annular inclined grid-shaped cone beam X-ray source (9), a sample table (5), an objective lens (6), an analysis grating (7) and an imaging detector. The X-ray differential phase contrast nano CT imaging method specifically includes an image collection method, a refraction angle imaging method, a linear absorption coefficient imaging method and a linear diffusion coefficient imaging method. The annular inclined grid-shaped cone beam illumination X-ray source is introduced, such that the defect of incomplete refraction angle sampling is overcome, thereby significantly improving the quality of a refraction angle reconstruction image. Meanwhile, a linear diffusion coefficient reconstruction image in two dimensions is provided, thus providing richer imaging information than traditional nano CT.

### TECHNICAL FIELD

The present invention relates to the field of X-ray nano CT imaging technologies, and in particular, to an X-ray differential phase contrast nano CT system and an imaging method therefor.

### BACKGROUND

The effect of a substance on X-rays can be represented by the refractive index n=1−δ+iβ, wherein δ and β are the phase shift term and the absorption term respectively. δ has the physical meaning of wave front movement generated by X-rays passing through a unit length of substance relative to X-rays passing through a unit length of vacuum; β has the physical meaning of a complex amplitude drop generated by X-rays passing through a unit length of substance. According to the physical meanings of δ and β, assuming that the complex amplitude of incident X-rays is 1, the X-rays have an exit complex amplitude which can be expressed as

$$\text{?}$$

$$\text{?} \text{indicates text missing or illegible when filed}$$

after passing through a sample, wherein φ and M are expressed as path integrals along the X-rays, φ is called a phase shift,

$$M = \frac{4 π}{λ} \int β dz = \int μ dz$$

is called absorption, and

$$μ = \frac{4 π}{λ} β$$

is called a linear attenuation coefficient. Since δ is more than three orders of magnitude greater than β of a light element in a hard X-ray band, a phase shift induced light intensity change is likely to be much greater than absorption induced light intensity attenuation.

The Dutch scientist Zernike was the first person in phase contrast imaging. As early as 1935, he proposed the theory and method of phase contrast nano CT in a visible band, for which he won the 1953 Nobel Prize in physics. Currently, the Zernike phase contrast nano CT method is successfully popularized to X-ray nano CT with a zone plate as an objective lens, and X-ray phase contrast nano CT obtaining a phase contrast with a phase shift ring is successfully developed. However, the phase contrast nano CT invented by Zernike has not solved a phase contrast quantification problem. There are two main reasons. First, the cross-sectional area occupied by the phase shift ring is larger than that occupied by zero-frequency light, and low-frequency light near the zero-frequency light is also phase-shifted while the zero-frequency light is phase-shifted, resulting in generation of halo artifacts. Second, under the condition of a weak phase shift with negligible absorption, the phase shift and a light intensity response approximately satisfy a linear relationship; when the absorption cannot be neglected, the light intensity response of the absorption and the light intensity response of the phase shift cannot be distinguished.

In order to realize quantification of phase contrast imaging in an X-ray microscope, two invention patents for X-ray differential phase contrast microscopes in which sample refraction is used have been issued. The first patent is an absorption ring-based X-ray differential phase contrast microscope (patent application No. 201210592499.0) and the second patent is a grating-based X-ray differential phase contrast microscope (patent application No. 201610617865.1). Since the two X-ray differential phase contrast microscopes are based on the following refractive index phase shift term reconstruction formula:

$$δ ( {x}^{′} , {y}^{′} , {z}^{′} ) = - \text{?} d φ \text{?} {ℱ}_{c}^{- 1} \text{?} {ℱ}_{x} [ {θ}_{x} ( x , y , φ ) ] \text{?} ( {x}^{′} cos φ + {z}^{′} sin φ - x ) dx ,$$

$$\text{?} \text{indicates text missing or illegible when filed}$$

the refraction angle horizontal component θₓ (i.e., the refraction angle component perpendicular to a sample rotation axis) is collected and utilized, and the refraction angle vertical component θ_{y} (i.e., the component parallel to the sample rotation axis) is absent, horizontal strip artifacts may occur in reconstructed coronal and sagittal images, such that refractive index phase shift terms are difficult to reconstruct perfectly. Although an invention patent (patent application No. 202211147928.3) in which the refraction angle horizontal component θₓ and the refraction angle vertical component Oy are simultaneously sampled by using a tilted grating has been disclosed to solve the problem of incomplete sampling, how to apply the tilted grating to the X-ray differential phase contrast nano CT and derive a specific imaging method is a blank in both academic and industrial circles at present.

### SUMMARY

### Technical Problem

In order to solve the problem in the BACKGROUND that the existing X-ray differential phase contrast nano CT has incomplete information collection, which causes existence of the horizontal strip artifacts in the reconstructed image, or the like, such that the image is difficult to distinguish and read, in the present invention, by introducing an annular inclined grating X-ray cone beam illumination in the X-ray nano CT, and simultaneously collecting and utilizing a refraction angle horizontal component and a refraction angle vertical component, the reconstruction quality of a refraction angle image is improved. The present invention further provides an image collection method, a refraction angle imaging method, a linear absorption coefficient imaging method and a linear diffusion coefficient imaging method for the X-ray differential phase contrast nano CT.

### Technical Solution

The present invention has the following technical solution.

An X-ray differential phase contrast nano CT system includes: an annular inclined grid-shaped cone beam X-ray source, a sample table, an objective lens, an analysis grating and an imaging detector.

The annular inclined grid-shaped cone beam X-ray source is a monochromatic X-ray light source and configured to provide a hollow cone beam with a spatial inclined grating structure; a middle part of the annular inclined grid-shaped cone beam X-ray source has a light intensity of 0.

The grating structure of the annular inclined grid-shaped cone beam X-ray source has a period of a micron order; a grating inclination angle of the annular inclined grid-shaped cone beam X-ray source is 0° to 90°.

The sample table is located on an object plane, is configured to bear a sample, and can translate and rotate the sample.

The objective lens is a zone plate or another optical element with an X-ray lens imaging function and is configured to amplify a sample structure with a nanoscale on the object plane into an image with a micron order structure on an image plane, and cause an annular part on a grid-shaped structure of the annular inclined grid-shaped cone beam X-ray source illuminated by the hollow cone beam to form an annular grating image and an annular grating image beam near a back focal plane of the objective lens.

The analysis grating is an absorption grating with a period of a micron or submicron order, is located near the back focal plane of the objective lens, has a same shape and size as the annular grating image of the grid-shaped structure of the annular inclined grid-shaped cone beam X-ray source near the back focal plane of the objective lens, and is configured to filter the annular grating image beam near the back focal plane of the objective lens.

An imaging method for an X-ray differential phase contrast nano CT system includes refraction angle imaging and linear diffusion coefficient imaging, and is used for shooting a two-dimensional amplified image of a sample.

A refraction angle imaging method for an X-ray differential phase contrast nano CT system according to the present invention includes the following steps:
S10: determining whether sample scattering is ignored;
S11: when the sample scattering is not ignored, calculating a refraction image horizontal component of a sample under an object plane grating coordinate;
when a rotation angle of the sample is φ, a refraction angle image of the sample on an image plane being

$${θ}_{{x}^{″}} ( X , Y , φ ) = \frac{p}{2 π ( {d}_{i} - {s}_{i} )} arc tan \frac{{I}_{U} ( X , Y , φ ) - {I}_{D} ( X , Y , φ )}{{I}_{V} ( X , Y , φ ) - {I}_{P} ( X , Y , φ )} ,$$

a refraction angle image of the sample under the object plane grating coordinate being

$${θ}_{{x}^{″}} ( x , y , φ ) = \frac{p \text{?}}{2 π ( {s}_{o} - \text{?} ) \text{?}} arc tan \frac{{I}_{U} ( X , Y , φ ) - {I}_{D} ( X , Y , φ )}{{I}_{V} ( X , Y , φ ) - {I}_{P} ( X , Y , φ )} ;$$

$$\text{?} \text{indicates text missing or illegible when filed}$$

S12: when the sample scattering is not ignored, calculating a refraction image vertical component of the sample under the object plane grating coordinate;
when the rotation angle is φ+π, the refraction angle image of the sample on the image plane being

$${θ}_{{y}^{″}} ( X , Y , φ ) = \frac{p}{2 π ( {d}_{i} - \text{?} )} arc tan \frac{{I}_{U} ( - X , Y , φ + π ) - {I}_{D} ( - X , Y , φ + π )}{{I}_{V} ( - X , Y , φ + π ) - {I}_{P} ( - X , Y , φ + π )} ,$$

$$\text{?} \text{indicates text missing or illegible when filed}$$

the refraction angle image of the sample under the object plane grating coordinate being

$${θ}_{{y}^{″}} ( x , y , φ ) = \frac{p {s}_{o}}{2 π ( {s}_{o} - {d}_{o} ) \text{?}} arc tan \frac{{I}_{U} ( - X , Y , φ + π ) - {I}_{D} ( - X , Y , φ + π )}{\text{?} ( - X , Y , φ + π ) - {I}_{P} ( - X , Y , φ + π )} ,$$

$$\text{?} \text{indicates text missing or illegible when filed}$$

wherein p is a period of an analysis grating, dₒ is an object distance of the sample relative to an objective lens, and dᵢ is an image distance of the sample relative to the objective lens; Sₒ is an object distance of a grid-shaped structure of the annular inclined grid-shaped cone beam X-ray source relative to the objective lens, and Sᵢ is an image distance of the grid-shaped structure of the annular inclined grid-shaped cone beam X-ray source relative to the objective lens;
S13: when the sample scattering is ignored, calculating the refraction image horizontal component of the sample under the object plane grating coordinate;
when the rotation angle is φ, the refraction angle image of the sample on the image plane being capable of being expressed as the following formula by an ascending amplified image and a descending amplified image:

$${θ}_{{x}^{″}} ( X , Y , φ ) = \frac{p}{2 π ( \text{?} {s}_{i} )} arc sin \frac{{I}_{U} ( X , Y , φ ) - {I}_{D} ( X , Y , φ )}{{I}_{U} ( X , Y , φ ) + {I}_{D} ( X , Y , φ )} \cdot \frac{{R}_{max} + {R}_{min}}{{R}_{max} - {R}_{min}}$$

$$\text{?} \text{indicates text missing or illegible when filed}$$

the refraction angle image of the sample under the object plane grating coordinate being

$${θ}_{{x}^{″}} ( x , y , φ ) = \frac{p \text{?}}{2 π ( \text{?} - \text{?} ) \text{?}} arc sin \frac{{I}_{U} ( X , Y , φ ) - {I}_{D} ( X , Y , φ )}{{I}_{U} ( X , Y , φ ) + {I}_{D} ( X , Y , φ )} \cdot \frac{{R}_{max} + {R}_{min}}{{R}_{max} - {R}_{min}} ;$$

$$\text{?} \text{indicates text missing or illegible when filed}$$

S14: when the sample scattering is ignored, calculating the refraction image vertical component of the sample under the object plane grating coordinate;
when the rotation angle is φ+π, the refraction angle image of the sample on the image plane being capable of being expressed as the following formula by the ascending amplified image and the descending amplified image:

$${θ}_{{y}^{″}} ( X , Y , φ ) = \frac{p}{2 π ( {d}_{i} - {s}_{i} )} arc sin \frac{{I}_{U} ( - X , Y , φ + π ) - {I}_{D} ( - X , Y , φ + π )}{{I}_{U} ( - X , Y , φ + π ) + {I}_{D} ( - X , Y , φ + π )} \cdot \frac{{R}_{max} + {R}_{min}}{{R}_{max} - {R}_{min}}$$

the refraction angle image of the sample under the object plane grating coordinate being

$${θ}_{{y}^{″}} ( x , y , φ ) = \frac{p \text{?}}{2 π ( \text{?} - \text{?} ) {s}_{i}} arc sin \frac{{I}_{U} ( - X , Y , φ + π ) - {I}_{D} ( - X , Y , φ + π )}{{I}_{U} ( - X , Y , φ + π ) + {I}_{D} ( - X , Y , φ + π )} \cdot \frac{{R}_{max} + {R}_{min}}{{R}_{max} - {R}_{min}} ;$$

$$\text{?} \text{indicates text missing or illegible when filed}$$

S15: calculating a refraction image horizontal component of the sample under an object plane natural coordinate; the refraction image horizontal component under the natural coordinate being capable of being expressed as the following formula by the collected refraction angle component under the grating coordinate:

$$\text{?} ( x , y , φ ) = \frac{{θ}_{{x}^{″}} ( x , y , φ ) - {θ}_{{y}^{″}} ( x , y , φ )}{2 cos ω} = \frac{{θ}_{{x}^{″}} ( x , y , φ ) - {θ}_{{x}^{″}} ( - x , y , φ + π )}{2 cos ω} ,$$

$$0 ° \leq ω \leq 90 ° ;$$

$$\text{?} \text{indicates text missing or illegible when filed}$$

S16: calculating a refraction image vertical component of the sample under the object plane natural coordinate; the refraction image vertical component under the natural coordinate being capable of being expressed as the following formula by the collected refraction angle component under the grating coordinate:

$$\text{?} ( x , y , φ ) = \frac{{θ}_{{x}^{″}} ( x , y , φ ) - {θ}_{{y}^{″}} ( x , y , φ )}{2 sin ω} = \frac{{θ}_{{x}^{″}} ( x , y , φ ) - {θ}_{{x}^{″}} ( - x , y , φ + π )}{2 sin ω} ,$$

$$0 ° \leq ω \leq 90 ° ;$$

$$\text{?} \text{indicates text missing or illegible when filed}$$

S17: reconstructing a gradient of a reduction of a real part of a refractive index of the sample under the object plane natural coordinate,

$$∇ δ ( \text{?} ) = {ℛ}^{- 1} [ - \text{?} ] = \text{?} d φ \text{?} [ - \text{?} ] \text{?} ( \text{?} cos φ + \text{?} sin φ - x ) dx$$

$$wherein \vec{θ} ( x , y , φ ) = ( {θ}_{x} ( x , y , φ ) \text{?} {θ}_{y} ( x , y , φ ) ) ;$$

$$\text{?} \text{indicates text missing or illegible when filed}$$

S18: reconstructing the reduction of the real part of the refractive index of the sample under the object plane natural coordinate,

$$\text{?} .$$

$$\text{?} \text{indicates text missing or illegible when filed}$$

The linear diffusion coefficient imaging includes the following steps:
S31: calculating a scattering variance image of a sample on an image plane, when the sample is on a sample table of X-ray differential phase contrast nano CT and a rotation angle is φ, the scattering variance image of the sample on the image plane being

$$\text{?} ( X , Y , φ ) = \frac{\text{?}}{2 {{π}^{2} ( \text{?} - \text{?} )}^{2}} ln \frac{\frac{{R}_{max} - {R}_{min}}{{R}_{max} + {R}_{min}}}{\begin{matrix}\sqrt{{[ \frac{\text{?} ( X , Y , φ ) - \text{?} ( X , Y , φ )}{\text{?} ( X , Y , φ ) + \text{?} ( X , Y , φ )} ]}^{2} +} \\ {[ \frac{\text{?} ( X , Y , φ ) - \text{?} ( X , Y , φ )}{\text{?} ( X , Y , φ ) + \text{?} ( X , Y , φ )} ]}^{2}\end{matrix}} ;$$

$$\text{?} \text{indicates text missing or illegible when filed}$$

S32: calculating a horizontal scattering variance image of the sample under an object plane grating coordinate, the horizontal scattering variance image of the sample under the object plane grating coordinate being

$$\text{?} ( x , y , φ ) = {[ \frac{\text{?}}{\text{?}} ]}^{2} \text{?} ( X , Y , φ ) = {\frac{{p}^{2}}{2 {π}^{2}} [ \frac{\text{?}}{\text{?}} ]}^{2} ln \frac{\frac{{R}_{max} - {R}_{min}}{{R}_{max} + {R}_{min}}}{\sqrt{\begin{matrix}{[ \frac{\text{?} ( X , Y , φ ) - \text{?} ( X , Y , φ )}{\text{?} ( X , Y , φ ) + \text{?} ( X , Y , φ )} ]}^{2} + \\ {[ \frac{\text{?} ( X , Y , φ ) - \text{?} ( X , Y , φ )}{\text{?} ( X , Y , φ ) + \text{?} ( X , Y , φ )} ]}^{2}\end{matrix}}}$$

$$\text{?} \text{indicates text missing or illegible when filed}$$

S33: calculating a vertical scattering variance image of the sample under the object plane grating coordinate, when the rotation angle is φ+π, a scattering variance image of the sample on an image plane being

$$\text{?} ( X , Y , φ ) = \text{?} ( - X , Y , φ + π ) = \text{?} ln \text{?}$$

$$\text{?} \text{indicates text missing or illegible when filed}$$

the vertical scattering variance image of the sample under the object plane grating coordinate being

$$\text{?} ( x , y , φ ) = \text{?} ( - x , y , φ + \text{?} ) = \text{?} ( - X , \text{?} + \text{?} ) = \frac{{p}^{2}}{2 {π}^{2}} \text{?} ln \frac{( \frac{{R}_{max} - {R}_{min}}{{R}_{max} + {R}_{min}} )}{\sqrt{\begin{matrix}{[ \frac{\text{?} ( - X , Y , φ + \text{?} ) - \text{?} ( - X , Y , φ + \text{?} )}{\text{?} ( - X , Y , φ + \text{?} ) + \text{?} ( - X , Y , φ + π )} ]}^{2} + \\ {[ \frac{\text{?} ( - X , Y , φ + \text{?} ) - \text{?} ( X , Y , φ + \text{?} )}{\text{?} ( - X , Y , φ + π ) + \text{?} ( X , Y , φ + \text{?} )} ]}^{2}\end{matrix}}}$$

$$\text{?} \text{indicates text missing or illegible when filed}$$

S34: reconstructing a horizontal linear diffusion coefficient of the sample under the object plane grating coordinate, a three-dimensional reconstruction formula of the horizontal linear diffusion coefficient being

$$\text{?} ( {x}^{′} , {y}^{′} , {z}^{′} ) = \text{?} [ \text{?} ( x , y , φ ) ] = \text{?} d φ \text{?} [ \text{?} ( x , y , φ ) ] \text{?} ( {x}^{′} cos φ + {z}^{′} sin φ - x ) dx ;$$

$$\text{?} \text{indicates text missing or illegible when filed}$$

S35: reconstructing a vertical linear diffusion coefficient of the sample under the object plane grating coordinate, a three-dimensional reconstruction formula of the vertical linear diffusion coefficient being

$$\text{?} ( {x}^{′} , {y}^{′} , {z}^{′} ) = \text{?} [ \text{?} ( x , y , φ ) ] = \text{?} d φ \text{?} [ \text{?} ( x , y , φ ) ] \text{?} ( {x}^{′} cos φ + \text{?} sin φ - x ) dx .$$

$$\text{?} \text{indicates text missing or illegible when filed}$$

### Beneficial Effects

The present invention has the following beneficial effects:
(1) compared with the traditional X-ray differential phase contrast nano CT, the annular inclined grid-shaped cone beam illumination X-ray source is introduced, such that the defect of incomplete sampling is overcome, thereby significantly improving the quality of the reconstruction image.
(2) the present invention provides the simple and feasible image collection method;
(3) compared with the traditional X-ray differential phase contrast nano CT, the linear diffusion coefficient imaging method according to the present invention can provide linear diffusion coefficient images in two directions, while the traditional method can only provide linear diffusion coefficient images in a single direction.

### BRIEF DESCRIPTION OF THE DRAWINGS

FIG. 1 shows an X-ray differential phase contrast nano CT system based on a grating;

FIG. 2 shows an X-ray differential phase contrast nano CT system based on an annular inclined grid-shaped cone beam X-ray source;

FIG. 3 is a schematic diagram of a relative relationship between the inclined grating and a sample (the arrow represents the sample); and

FIG. 4 is a flowchart of a refraction angle imaging method for an X-ray differential phase contrast nano CT system.

In the drawings:

1—X-ray light source, 2—diaphragm, 3—condensing lens, 4—beam splitting grating, 5—sample table, 6—objective lens, 7—analysis grating, 8—image plane, 9—annular inclined grid-shaped cone beam X-ray source.

### DETAILED DESCRIPTION OF THE EMBODIMENTS

An X-ray differential phase contrast nano CT system and an imaging method therefor according to embodiments of the present invention are described in detail below with reference to accompanying drawings, wherein an image collection method, a refraction angle imaging method, a linear absorption coefficient imaging method, and a linear diffusion coefficient imaging method for X-ray differential phase contrast nano CT according to the present invention are also included.

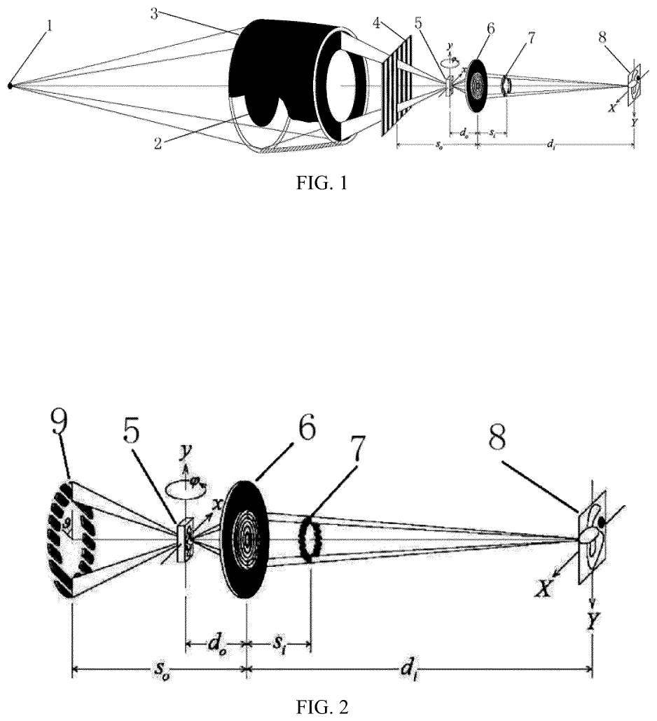

FIG. 1 shows an X-ray differential phase contrast nano CT system based on a grating, and internal elements thereof sequentially include an X-ray light source 1, a diaphragm 2, a condensing lens 3, a beam splitting grating 4, a sample table 5, an objective lens 6, an analysis grating 7 and an image plane 8 according to an X-ray propagation direction.

Elements of an X-ray differential phase contrast nano CT system based on an annular inclined grid-shaped cone beam X-ray source shown in FIG. 2 sequentially includes the annular inclined grid-shaped cone beam X-ray source 9, a sample table 5, an objective lens 6, an analysis grating 7 and an image plane 8 according to an X-ray propagation direction. Natures, structures and functions of the elements are described as follows.

The annular inclined grid-shaped cone beam X-ray source 9 is a monochromatic X-ray light source and configured to provide a hollow cone beam with a spatial inclined grating structure; a middle part thereof has a light intensity of 0;
further, the grating structure of the annular inclined grid-shaped cone beam X-ray source 9 has a period of a micron order; a grating inclination angle of the annular inclined grid-shaped cone beam X-ray source 9 is 0° to 90°.

The sample table 5 is located on an object plane, is configured to bear a sample, and can translate and rotate the sample.

The objective lens 6 is a zone plate or another optical element with an X-ray lens imaging function and is configured to amplify a sample structure with a nanoscale on the object plane into an image with a micron order structure on an image plane, and cause an annular part on a grid-shaped structure of the annular inclined grid-shaped cone beam X-ray source illuminated by the hollow cone beam to form an annular grating image and an annular grating image beam near a back focal plane of the objective lens.

The analysis grating 7 is an absorption grating with a period of a micron or submicron order, is located near the back focal plane of the objective lens, has a same shape and size as the annular grating image of the grid-shaped structure of the annular inclined grid-shaped cone beam X-ray source near the back focal plane of the objective lens, and is configured to filter the annular grating image beam near the back focal plane of the objective lens.

An imaging detector is located on the image plane 8 and configured to shoot a two-dimensional amplified image of the sample.

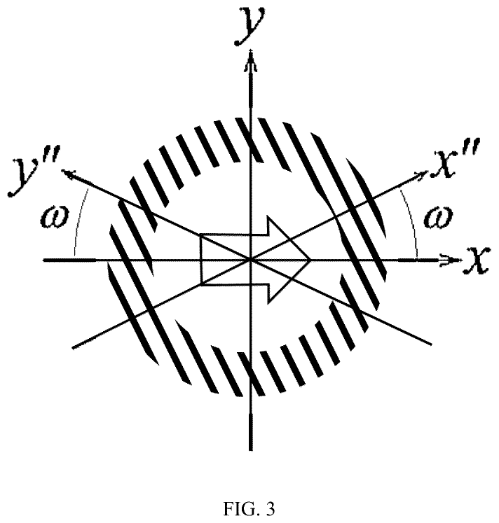

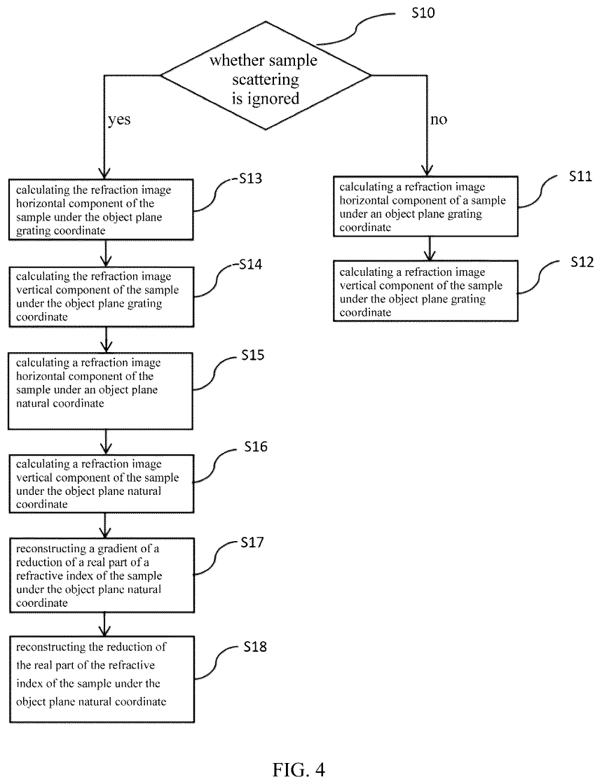

FIG. 3 shows a schematic diagram of a relative relationship between the inclined grating and the sample, and a style shown by the sample may have the function of supplementing a formula principle or imaging principle of the X-ray differential phase contrast nano CT system according to the present application.

The image collection method for an X-ray differential phase contrast nano CT system mentioned above includes the following steps:
S1: starting and adjusting an annular inclined grid-shaped cone beam X-ray source: aligning an X-ray hollow cone beam generated by the illumination light source with a sample;
S2: adjusting an objective lens: aligning an imaging beam formed by focusing of the objective lens with an imaging detector located on an image plane;
S3: feeding and adjusting an analysis grating: aligning an annular shape of the analysis grating with an annular grating image formed by a grid-shaped structure of the annular inclined grid-shaped cone beam X-ray source near a back focal plane of the objective lens, and rotating the grid-shaped structure of the annular inclined grid-shaped cone beam X-ray source or the analysis grating around an optical axis to cause the grid-shaped structure of the annular inclined grid-shaped cone beam X-ray source to be parallel to grating strips of the analysis grating;
S4: measuring an angle signal response curve: gradually moving the grid-shaped structure of the annular inclined grid-shaped cone beam X-ray source or the analysis grating along a direction perpendicular to the optical axis and the grating strips, so as to cause the annular grating image of the grid-shaped structure of the annular inclined grid-shaped cone beam X-ray source to generate shear displacement relative to the analysis grating, and measuring the angle signal response curve of a change of a light intensity along with displacement of the grating on the image plane by using the imaging detector;
S5: fitting the angle signal response curve with a cosine curve: since the angle signal response curve is similar to a cosine curve, fitting the measured angle signal response curve by using the cosine curve to obtain analytic expression of the cosine curve;
S6: shooting a two-dimensional amplified image of the sample: fixing the grid-shaped structure of the annular inclined grid-shaped cone beam X-ray source or the analysis grating on a valley position, an ascending position, a peak position and a descending position of the angle signal response curve, placing the sample on a sample table, and shooting a valley amplified image, an ascending amplified image, a peak amplified image and a descending amplified image of the sample;
S7: collecting a complete set of refraction angle images required by differential phase CT: gradually rotating the sample around a sample rotating shaft step by step from 0° to 360°, and shooting the valley amplified image, the ascending amplified image, the peak amplified image and the descending amplified image every time the sample is rotated by one step; that is, repeating the step S6 every time the sample is rotated by one step; and
S8: establishing an image plane coordinate system (X, Y) with a center of the sample image as an origin, the valley amplified image, the ascending amplified image, the peak amplified image and the descending amplified image which are shot by the detector when the rotation angle of the sample is φ being represented as IV(X, Y, φ), IU(X, Y, φ), IP(X, Y, φ) and ID(X, Y, φ) respectively.

The refraction angle imaging method for an X-ray differential phase contrast nano CT system mentioned above includes the following steps:
S10: determining whether sample scattering is ignored;
S11: when the sample scattering is not ignored, calculating a refraction image horizontal component of a sample under an object plane grating coordinate;
when a rotation angle of the sample is φ, a refraction angle image of the sample on an image plane being

$${θ}_{{x}^{″}} ( X , Y , φ ) = \frac{p}{2 π ( {d}_{i} - {s}_{i} )} arc tan \frac{{I}_{U} ( X , Y , φ ) - {I}_{D} ( X , Y , φ )}{{I}_{V} ( X , Y , φ ) - {I}_{P} ( X , Y , φ )} ,$$

a refraction angle image of the sample under the object plane grating coordinate being

$${θ}_{{x}^{″}} ( x , y , φ ) = \frac{p \text{?}}{2 π ( \text{?} - \text{?} ) \text{?}} arc tan \frac{{I}_{U} ( X , Y , φ ) - {I}_{D} ( X , Y , φ )}{{I}_{V} ( X , Y , φ ) - {I}_{P} ( X , Y , φ )} ;$$

$$\text{?} \text{indicates text missing or illegible when filed}$$

S12: when the sample scattering is not ignored, calculating a refraction image vertical component of the sample under the object plane grating coordinate;
when the rotation angle is φ+π, the refraction angle image of the sample on the image plane being

$${θ}_{{y}^{″}} ( X , Y , φ ) = \frac{p}{2 π ( \text{?} - \text{?} )} arc tan \frac{{I}_{U} ( - X , Y , φ + π ) - {I}_{D} ( - X , Y , φ + π )}{{I}_{V} ( - X , Y , φ + π ) - {I}_{P} ( - X , Y , φ + π )} ,$$

$$\text{?} \text{indicates text missing or illegible when filed}$$

the refraction angle image of the sample under the object plane grating coordinate being

$${θ}_{{y}^{″}} ( x , y , φ ) = \frac{p \text{?}}{2 π ( \text{?} - \text{?} ) {s}_{i}} arc tan \frac{{I}_{U} ( - X , Y , φ + π ) - {I}_{D} ( - X , Y , φ + π )}{{I}_{V} ( - X , Y , φ + π ) - {I}_{P} ( - X , Y , φ + π )} ,$$

$$\text{?} \text{indicates text missing or illegible when filed}$$

wherein p is a period of an analysis grating, dₒ is an object distance of the sample relative to an objective lens, and dᵢ is an image distance of the sample relative to the objective lens;
Sₒ is an object distance of a grid-shaped structure of the annular inclined grid-shaped cone beam X-ray source relative to the objective lens, and Sᵢ is an image distance of the grid-shaped structure of the annular inclined grid-shaped cone beam X-ray source relative to the objective lens;
S13: when the sample scattering is ignored, calculating the refraction image horizontal component of the sample under the object plane grating coordinate;
when the rotation angle is φ, the refraction angle image of the sample on the image plane being capable of being expressed as the following formula by an ascending amplified image and a descending amplified image:

$${θ}_{{x}^{″}} ( X , Y , φ ) = \frac{p}{2 π ( \text{?} - {s}_{i} )} arc sin \frac{{I}_{U} ( X , Y , φ ) - {I}_{D} ( X , Y , φ )}{{I}_{U} ( X , Y , φ ) + {I}_{D} ( X , Y , φ )} \cdot \frac{{R}_{max} + {R}_{min}}{{R}_{max} - {R}_{min}} ,$$

$$\text{?} \text{indicates text missing or illegible when filed}$$

the refraction angle image of the sample under the object plane grating coordinate being

$${θ}_{{x}^{″}} ( x , y , φ ) = \frac{p \text{?}}{2 π ( \text{?} - \text{?} ) \text{?}} arc sin \frac{{I}_{U} ( X , Y , φ ) - {I}_{D} ( X , Y , φ )}{{I}_{V} ( X , Y , φ ) - {I}_{P} ( X , Y , φ )} \cdot \frac{{R}_{max} + {R}_{min}}{{R}_{max} - {R}_{min}} ;$$

$$\text{?} \text{indicates text missing or illegible when filed}$$

S14: when the sample scattering is ignored, calculating the refraction image vertical component of the sample under the object plane grating coordinate;
when the rotation angle is φ+π, the refraction angle image of the sample on the image plane being capable of being expressed as the following formula by the ascending amplified image and the descending amplified image:

$${θ}_{{y}^{″}} ( X , Y , φ ) = \frac{p}{2 π ( \text{?} - {s}_{i} )} arc sin \frac{{I}_{U} ( - X , Y , φ + π ) - {I}_{D} ( - X , Y , φ + π )}{{I}_{U} ( - X , Y , φ + π ) + {I}_{D} ( - X , Y , φ + π )} \cdot \frac{{R}_{max} + \text{?}}{{R}_{max} - {R}_{min}} ,$$

$$\text{?} \text{indicates text missing or illegible when filed}$$

the refraction angle image of the sample under the object plane grating coordinate being

$${θ}_{{y}^{″}} ( x , y , φ ) = \frac{p \text{?}}{2 π ( \text{?} - \text{?} ) \text{?}} arc sin \frac{{I}_{U} ( - X , Y , φ + π ) - {I}_{D} ( - X , Y , φ + π )}{{I}_{U} ( - X , Y , φ + π ) - {I}_{D} ( - X , Y , φ + π )} \cdot \frac{{R}_{max} + {R}_{min}}{{R}_{max} - {R}_{min}} ;$$

$$\text{?} \text{indicates text missing or illegible when filed}$$

S15: calculating a refraction image horizontal component of the sample under an object plane natural coordinate; the refraction image horizontal component under the natural coordinate being capable of being expressed as the following formula by the collected refraction angle component under the grating coordinate:

$${θ}_{x} ( x , y , φ ) = \frac{{θ}_{{x}^{″}} ( x , y , φ ) - {θ}_{{y}^{″}} ( x , y , φ )}{2 cos ω} = \frac{{θ}_{{x}^{″}} ( x , y , φ ) - {θ}_{{x}^{″}} ( - x , y , φ + π )}{2 cos ω} ,$$

$$0 ° \leq ω \leq 90 ° ;$$

S16: calculating a refraction image vertical component of the sample under the object plane natural coordinate; the refraction image vertical component under the natural coordinate being capable of being expressed as the following formula by the collected refraction angle component under the grating coordinate:

$${θ}_{y} ( x , y , φ ) = \frac{{θ}_{{x}^{″}} ( x , y , φ ) + {θ}_{{y}^{″}} ( x , y , φ )}{2 sin ω} = \frac{{θ}_{{x}^{″}} ( x , y , φ ) + {θ}_{{x}^{″}} ( x , y , φ )}{2 sin ω} , 0 ° \leq ω \leq 90 ° ;$$

S17: reconstructing a gradient of a reduction of a real part of a refractive index of the sample under the object plane natural coordinate,

$$∇ δ ( {x}^{′} , {y}^{′} , {z}^{′} ) = {ℛ}^{- 1} [ - \vec{θ} ( x , y , φ ) ] = {\int }_{0}^{π} d φ {\int }_{- ∞}^{∞} {ℱ}_{x}^{- 1} \vert ρ \vert {ℱ}_{x} [ - \vec{θ} ( x , y , φ ) ] \hat{δ} ( {x}^{′} cos φ + {z}^{′} sin φ - x ) dx$$

$$wherein \vec{θ} ( x , y , φ ) = ( {θ}_{x} ( x , y , φ ) , {θ}_{y} ( x , y , φ ) ) ;$$

S18: reconstructing the reduction of the real part of the refractive index of the sample under the object plane natural coordinate,

$$\text{?}$$

$$\text{?} \text{indicates text missing or illegible when filed}$$

The linear attenuation coefficient imaging method for an X-ray differential phase contrast nano CT system mentioned above includes the following steps:
S21: calculating an absorption image of a sample on an image plane, when the sample is on a sample table of X-ray differential phase contrast nano CT and a rotation angle is φ, the absorption image of the sample on the image plane being

$$M ( X , Y , φ ) = ln \frac{2 {I}_{0} ( {R}_{max} + {R}_{min} )}{{I}_{V} ( X , Y , φ ) + {I}_{U} ( X , Y , φ ) + {I}_{P} ( X , Y , φ ) + {I}_{D} ( X , Y , φ )} ;$$

wherein I₀ is an incident light intensity of the sample, and Rₘₐₓ and Rₘᵢₙ are a maximum value and a minimum value of an angle signal response curve respectively;
S22: calculating an absorption image of the sample on an object plane, the absorption image of the sample on the object plane being

$$M ( x , y , φ ) = M ( X , Y , φ ) = ln \frac{2 {I}_{0} ( {R}_{max} + {R}_{min} )}{{I}_{V} ( X , Y , φ ) + {I}_{U} ( X , Y , φ ) + {I}_{P} ( X , Y , φ ) + {I}_{D} ( X , Y , φ )} ;$$

S23: reconstructing a linear attenuation coefficient of the sample on the object plane; a three-dimensional reconstruction formula of the linear attenuation coefficient being

$$μ ( {x}^{′} , {y}^{′} , {z}^{′} ) = {ℛ}^{- 1} [ M ( x , y , φ ) ] = {{{\int }_{0}}^{π}}^{} d φ {{{\int }_{- ∞}}^{∞}}^{} {ℱ}_{x}^{- 1} \frac{\vert ρ \vert}{2 π i ρ} {ℱ}_{x} [ M ( x , y , φ ) ] \hat{δ} ( {x}^{′} cos φ + {z}^{′} sin φ - x ) dx .$$

The linear diffusion coefficient imaging method for an X-ray differential phase contrast nano CT system mentioned above includes the following steps:
S31: calculating a scattering variance image of a sample on an image plane, when the sample is on a sample table of X-ray differential phase contrast nano CT and a rotation angle is p, the scattering variance image of the sample on the image plane being

$${σ}_{{x}^{″}}^{2} ( X , Y , φ ) = \frac{{p}^{2}}{2 {{π}^{2} ( {d}_{i} - {s}_{i} )}^{2}} ln \frac{\frac{{R}_{max} - {R}_{min}}{{R}_{max} + {R}_{min}}}{\sqrt{{[ \frac{{I}_{V} ( X , Y , φ ) - {I}_{P} ( X , Y , φ )}{{I}_{V} ( X , Y , φ ) + {I}_{P} ( X , Y , φ )} ]}^{2} + {[ \frac{{I}_{U} ( X , Y , φ ) - {I}_{D} ( X , Y , φ )}{{I}_{U} ( X , Y , φ ) + {I}_{D} ( X , Y , φ )} ]}^{2}}} ;$$

S32: calculating a horizontal scattering variance image of the sample under an object plane grating coordinate, the horizontal scattering variance image of the sample under the object plane grating coordinate being

$${σ}_{{x}^{″}}^{2} ( x , y , φ ) = {[ \frac{{s}_{o} ( {d}_{i} - {s}_{i} )}{( {s}_{o} - {d}_{o} ) {s}_{i}} ]}^{2} {σ}_{{x}^{″}}^{2} ( X , Y , φ ) = {\frac{{p}^{2}}{2 {π}^{2}} [ \frac{{s}_{o}}{( {s}_{o} - {d}_{o} ) {s}_{i}} ]}^{2} ln \frac{\frac{{R}_{max} - {R}_{min}}{{R}_{max} + {R}_{min}}}{\sqrt{{[ \frac{{I}_{V} ( X , Y , φ ) - {I}_{P} ( X , Y , φ )}{{I}_{V} ( X , Y , φ ) + {I}_{P} ( X , Y , φ )} ]}^{2} + {[ \frac{{I}_{U} ( X , Y , φ ) - {I}_{D} ( X , Y , φ )}{{I}_{U} ( X , Y , φ ) + {I}_{D} ( X , Y , φ )} ]}^{2}}}$$

S33: calculating a vertical scattering variance image of the sample under the object plane grating coordinate, when the rotation angle is φ+π, a scattering variance image of the sample on an image plane being

$${σ}_{{y}^{″}}^{2} ( X , Y , φ ) = {σ}_{{x}^{″}}^{2} ( - X , Y , φ + π ) = \frac{{p}^{2}}{2 {{π}^{2} ( {d}_{i} - {s}_{i} )}^{2}} ln \frac{\frac{{R}_{max} - {R}_{min}}{{R}_{max} + {R}_{min}}}{\sqrt{{[ \frac{{I}_{V} ( - X , Y , φ + π ) - {I}_{P} ( - X , Y , φ + π )}{{I}_{V} ( - X , Y , φ + π ) + {I}_{P} ( - X , Y , φ + π )} ]}^{2} + {[ \frac{{I}_{U} ( - X , Y , φ + π ) - {I}_{D} ( - X , Y , φ + π )}{{I}_{U} ( - X , Y , φ + π ) + {I}_{D} ( - X , Y , φ + π )} ]}^{2}}} ;$$

the vertical scattering variance image of the sample under the object plane grating coordinate being

$${σ}_{{x}^{″}}^{2} ( x , y , φ ) = {σ}_{{x}^{″}}^{2} ( - x , y , φ + π ) = {[ \frac{{s}_{o} ( {d}_{i} - {s}_{i} )}{( {s}_{o} - {d}_{o} ) {s}_{i}} ]}^{2} {σ}_{{y}^{″}}^{2} ( - X , Y , φ + π ) = {\frac{{p}^{2}}{2 {π}^{2}} [ \frac{{s}_{o}}{( {s}_{o} - {d}_{o} ) {s}_{i}} ]}^{2} ln \frac{\frac{{R}_{max} - {R}_{min}}{{R}_{max} + {R}_{min}}}{\sqrt{{[ \frac{{I}_{V} ( - X , Y , φ + π ) - {I}_{P} ( - X , Y , φ + π )}{{I}_{V} ( - X , Y , φ + π ) + {I}_{P} ( - X , Y , φ + π )} ]}^{2} + {[ \frac{{I}_{U} ( - X , Y , φ + π ) - {I}_{D} ( - X , Y , φ + π )}{{I}_{U} ( - X , Y , φ + π ) + {I}_{D} ( - X , Y , φ + π )} ]}^{2}}}$$

S34: reconstructing a horizontal linear diffusion coefficient of the sample under the object plane grating coordinate, a three-dimensional reconstruction formula of the horizontal linear diffusion coefficient being

$${ω}_{{x}^{″}} ( {x}^{′} , {y}^{′} , {z}^{′} ) = {ℛ}^{- 1} [ {σ}_{{x}^{″}}^{2} ( x , y , φ ) ] = {\int }_{0}^{π} d φ {\int }_{- ∞}^{∞} {ℱ}_{x}^{- 1} \frac{\vert ρ \vert}{2 π i ρ} {ℱ}_{x} [ {σ}_{{x}^{″}}^{2} ( x , y , φ ) ] \hat{δ} ( {x}^{′} cos φ + {z}^{′} sin φ - x ) dx ;$$

S35: reconstructing a vertical linear diffusion coefficient of the sample under the object plane grating coordinate, a three-dimensional reconstruction formula of the vertical linear diffusion coefficient being

$${ω}_{{y}^{″}} ( {x}^{′} , {y}^{′} , {z}^{′} ) = {ℛ}^{- 1} [ {σ}_{{y}^{″}}^{2} ( x , y , φ ) ] = {\int }_{0}^{2 π} d φ {\int }_{- ∞}^{∞} {ℱ}_{x}^{- 1} \frac{\vert ρ \vert}{2 π i ρ} {ℱ}_{x} [ {σ}_{{y}^{″}}^{2} ( x , y , φ ) ] \hat{δ} ( {x}^{′} cos φ + {z}^{′} sin φ - x ) dx .$$

The foregoing description is only a preferred embodiment of the application and is illustrative of the principles of the employed technology. It will be appreciated by those skilled in the art that the scope of the application is not limited to technical solutions resulting from particular combinations of the above technical features, but also should encompass other technical solutions resulting from any combination of such technical features or their equivalents, for example, technical solutions formed by replacing the above features and technical features (but not limited to) having similar functions disclosed in the present application with each other, without departing from the inventive concept.

1. An imaging method for an X-ray differential phase contrast nano CT system, wherein the X-ray differential phase contrast nano CT system comprises an annular inclined grid-shaped cone beam X-ray source, a sample table, an objective lens, an analysis grating and an imaging detector, and the annular inclined grid-shaped cone beam X-ray source comprises a grid-shaped structure; the imaging method comprises refraction angle imaging and linear diffusion coefficient imaging, and the refraction angle imaging comprises the following steps:
S10: determining whether sample scattering is ignored;
S11: when the sample scattering is not ignored, calculating a refraction image horizontal component of a sample under an object plane grating coordinate, when a rotation angle of the sample is φ, a refraction angle image of the sample on an image plane being
$${θ}_{{x}^{″}} ( X , Y , φ ) = \frac{p}{2 π ( {d}_{i} - {s}_{i} )} arctan \frac{{I}_{U} ( X , Y , φ ) - {I}_{D} ( X , Y , φ )}{{I}_{V} ( X , Y , φ ) - {I}_{P} ( X , Y , φ )} ,$$
a refraction angle image of the sample under the object plane grating coordinate being
$${θ}_{{x}^{″}} ( x , y , φ ) = \frac{{ps}_{∘}}{2 π ( {s}_{o} - {d}_{o} ) {s}_{i}} arctan \frac{{I}_{U} ( X , Y , φ ) - {I}_{D} ( X , Y , φ )}{{I}_{V} ( X , Y , φ ) - {I}_{P} ( X , Y , φ )} ;$$
S12: when the sample scattering is not ignored, calculating a refraction image vertical component of the sample under the object plane grating coordinate, when the rotation angle is φ+π, the refraction angle image of the sample on the image plane being
$${θ}_{{y}^{″}} ( X , Y , φ ) = \frac{p}{2 π ( {d}_{i} - {s}_{i} )} arctan \frac{{I}_{U} ( - X , Y , φ + π ) - {I}_{D} ( - X , Y , φ + π )}{{I}_{V} ( - X , Y , φ + π ) - {I}_{P} ( - X , Y , φ + π )} ,$$
the refraction angle image of the sample under the object plane grating coordinate being
$${θ}_{{y}^{′′}} ( x , y , φ ) = \frac{p {s}_{o}}{2 π ( {s}_{o} - {d}_{o} ) {s}_{i}} arc tan \frac{{I}_{U} ( - X , Y , φ + π ) - {I}_{D} ( - X , Y , φ + π )}{{I}_{V} ( - X , Y , φ + π ) - {I}_{P} ( - X , Y , φ + π )} ;$$
S13: when the sample scattering is ignored, calculating the refraction image horizontal component of the sample under the object plane grating coordinate, when the rotation angle is φ, the refraction angle image of the sample on the image plane being capable of being expressed as the following formula by an ascending amplified image and a descending amplified image:
$${θ}_{{x}^{′′}} ( X , Y , φ ) = \frac{p}{2 π ( {d}_{i} - {s}_{i} )} arc sin \frac{{I}_{U} ( X , Y , φ ) - {I}_{D} ( X , Y , φ )}{{I}_{U} ( X , Y , φ ) + {I}_{D} ( X , Y , φ )} \cdot \frac{{R}_{m ax} + {R}_{m i n}}{{R}_{ma x} - {R}_{m i n}} ,$$
the refraction angle image of the sample under the object plane grating coordinate being
$${θ}_{{x}^{′′}} ( x , y , φ ) = \frac{p {s}_{o}}{2 π ( {s}_{o} - {d}_{o} ) {s}_{i}} arc sin \frac{{I}_{U} ( X , Y , φ ) - {I}_{D} ( X , Y , φ )}{{I}_{U} ( X , Y , φ ) + {I}_{D} ( X , Y , φ )} \cdot \frac{{R}_{m ax} + {R}_{m i n}}{{R}_{ma x} - {R}_{m i n}} ;$$
S14: when the sample scattering is ignored, calculating the refraction image vertical component of the sample under the object plane grating coordinate, when the rotation angle is φ+π, the refraction angle image of the sample on the image plane being capable of being expressed as the following formula by the ascending amplified image and the descending amplified image:
$${θ}_{{y}^{′′}} ( X , Y , φ ) = \frac{p}{2 π ( {d}_{i} - {s}_{i} )} arc sin \frac{{I}_{U} ( - X , Y , φ + π ) - {I}_{D} ( - X , Y , φ + π )}{{I}_{U} ( - X , Y , φ + π ) + {I}_{D} ( - X , Y , φ + π )} \cdot \frac{{R}_{m ax} + {R}_{m i n}}{{R}_{ma x} - {R}_{m i n}} ,$$
the refraction angle image of the sample under the object plane grating coordinate being
$${θ}_{{y}^{′′}} ( x , x , φ ) = \frac{p}{2 π ( {s}_{o} - {d}_{o} ) {s}_{i}} arc sin \frac{{I}_{U} ( - X , Y , φ + π ) - {I}_{D} ( - X , Y , φ + π )}{{I}_{U} ( - X , Y , φ + π ) + {I}_{D} ( - X , Y , φ + π )} \cdot \frac{{R}_{m ax} + {R}_{m i n}}{{R}_{ma x} - {R}_{m i n}} ;$$
S15: calculating a refraction image horizontal component of the sample under an object plane natural coordinate; the refraction image horizontal component under the natural coordinate being capable of being expressed as the following formula by the collected refraction angle component under the grating coordinate:
$${θ}_{x} ( x , y , φ ) = \frac{{θ}_{{x}^{′′}} ( x , y , φ ) - {θ}_{{y}^{′′}} ( x , y , φ )}{2 cos ω} = \frac{{θ}_{{x}^{′′}} ( x , y , φ ) - {θ}_{{x}^{′′}} ( - x , y , φ + π )}{2 cos ω} ;$$
S16: calculating a refraction image vertical component of the sample under the object plane natural coordinate; the refraction image vertical component under the natural coordinate being capable of being expressed as the following formula by the collected refraction angle component under the grating coordinate:
$${θ}_{y} ( x , y , φ ) = \frac{{θ}_{{x}^{′′}} ( x , y , φ ) + {θ}_{{y}^{′′}} ( x , y , φ )}{2 sin ω} = \frac{{θ}_{{x}^{′′}} ( x , y , φ ) + {θ}_{{x}^{′′}} ( - x , y , φ + π )}{2 sin ω} ;$$
S17: reconstructing a gradient of a reduction of a real part of a refractive index of the sample under the object plane natural coordinate,
$$\begin{matrix}∇ δ ( {x}^{′} , {y}^{′} , {z}^{′} ) = {ℛ}^{- 1} [ - \vec{θ} ( x , y , φ ) ] \\ = {\int }_{0}^{π} d φ {\int }_{- ∞}^{∞} {ℱ}_{x}^{- 1} \vert ρ \vert {ℱ}_{x} [ - \vec{θ} ( x , y , φ ) ] \\ \hat{δ} ( {x}^{′} cos φ + {z}^{′} sin φ - x ) dx ;\end{matrix}$$
S18: reconstructing the reduction of the real part of the refractive index of the sample under the object plane natural coordinate,
$$δ ( {x}^{′} , {y}^{′} , {z}^{′} ) = - {\int }_{0}^{π} d φ {\int }_{- ∞}^{∞} {ℱ}_{y}^{- 1} {ℱ}_{x}^{- 1} \frac{\vert ρ \vert}{2 π ( {ρ}^{2} + {v}^{2} )} ( ρ {ℱ}_{x} {ℱ}_{y} {θ}_{x} ( x , y , φ ) + v {ℱ}_{x} {ℱ}_{y} {θ}_{y} ( x , y , φ ) ) \hat{δ} ( {x}^{′} cos φ + {z}^{′} sin φ - x ) dx ;$$
the linear diffusion coefficient imaging comprises the following steps:
S31: calculating a scattering variance image of a sample on an image plane, when the sample is on the sample table of X-ray differential phase contrast nano CT and a rotation angle is φ, the scattering variance image of the sample on the image plane being
$${σ}_{{x}^{′′}}^{2} ( X , Y , φ ) = \frac{{p}^{2}}{2 {{π}^{2} ( {d}_{i} - {s}_{i} )}^{2}} ln \frac{\frac{{R}_{m ax} - {R}_{m i n}}{{R}_{m ax} + {R}_{m i n}}}{\sqrt{{[ \frac{{I}_{v} ( X , Y , φ ) - {I}_{P} ( X , Y , φ )}{{I}_{V} ( X , Y , φ ) + {I}_{P} ( X , Y , φ )} ]}^{2} + {[ \frac{{I}_{U} ( X , Y , φ ) - {I}_{D} ( X , Y , φ )}{{I}_{U} ( X , Y , φ ) + {I}_{D} ( X , Y , φ )} ]}^{2}}} ;$$
S32: calculating a horizontal scattering variance image of the sample under an object plane grating coordinate, the horizontal scattering variance image of the sample under the object plane grating coordinate being
$$\begin{matrix}{σ}_{{x}^{′′}}^{2} ( x , y , φ ) = {[ \frac{{s}_{o} ( {d}_{i} - {s}_{i} )}{( {s}_{o} - {d}_{o} ) {s}_{i}} ]}^{2} {σ}_{{x}^{′′}}^{2} ( X , Y , φ ) \\ = {\frac{{p}^{2}}{2 {π}^{2}} [ \frac{{s}_{o}}{( {s}_{o} - {d}_{o} ) {s}_{i}} ]}^{2} \\ ln \frac{\frac{{R}_{m ax} - {R}_{m i n}}{{R}_{m ax} + {R}_{m i n}}}{\sqrt{\begin{matrix}{[ \frac{{I}_{V} ( X , Y , φ ) - {I}_{P} ( X , Y , φ )}{{I}_{V} ( X , Y , φ ) + {I}_{P} ( X , Y , φ )} ]}^{2} + \\ {[ \frac{{I}_{U} ( X , Y , φ ) - {I}_{D} ( X , Y , φ )}{{I}_{U} ( X , Y , φ ) + {I}_{D} ( X , Y , φ )} ]}^{2}\end{matrix}}}\end{matrix}$$
S33: calculating a vertical scattering variance image of the sample under the object plane grating coordinate, when the rotation angle is φ+π, a scattering variance image of the sample on an image plane being
$$\begin{matrix}{σ}_{{y}^{′′}}^{2} ( X , Y , φ ) = {σ}_{{x}^{′′}}^{2} ( - X , Y , φ + π ) \\ = \frac{{p}^{2}}{2 {{π}^{2} ( {d}_{i} - {s}_{i} )}^{2}} \\ ln \frac{\frac{{R}_{ma x} - {R}_{m i n}}{{R}_{m ax} + {R}_{m i n}}}{\sqrt{\begin{matrix}{[ \frac{{I}_{V} ( - X , Y , φ + π ) - {I}_{P} ( - X , Y , φ + π )}{{I}_{V} ( - X , Y , φ + π ) + {I}_{P} ( - X , Y , φ + π )} ]}^{2} + \\ {[ \frac{{I}_{U} ( - X , Y , φ + π ) - {I}_{D} ( - X , Y , φ + π )}{{I}_{U} ( - X , Y , φ + π ) + {I}_{D} ( - X , Y , φ + π )} ]}^{2}\end{matrix}}}\end{matrix}$$
the vertical scattering variance image of the sample under the object plane grating coordinate being
$$\begin{matrix}{σ}_{{y}^{′′}}^{2} ( x , y , φ ) = {σ}_{{x}^{′′}}^{2} ( - x , y , φ + π ) \\ = {[ \frac{{s}_{o} ( {d}_{i} - {s}_{i} )}{( {s}_{o} - {d}_{o} ) {s}_{i}} ]}^{2} {σ}_{{x}^{′′}}^{2} ( - X , Y , φ + π ) \\ = {\frac{{p}^{2}}{2 {π}^{2}} [ \frac{{s}_{o}}{( {s}_{o} - {d}_{o} ) {s}_{i}} ]}^{2} \\ ln \frac{\frac{{R}_{m ax} - {R}_{m i n}}{{R}_{m ax} + {R}_{m i n}}}{\sqrt{\begin{matrix}{[ \frac{{I}_{V} ( - X , Y , φ + π ) - {I}_{P} ( - X , Y , φ + π )}{{I}_{V} ( - X , Y , φ + π ) + {I}_{P} ( - X , Y , φ + π )} ]}^{2} + \\ {[ \frac{{I}_{U} ( - X , Y , φ + π ) - {I}_{D} ( - X , Y , φ + π )}{{I}_{U} ( - X , Y , φ + π ) + {I}_{D} ( - X , Y , φ + π )} ]}^{2}\end{matrix}}}\end{matrix}$$
S34: reconstructing a horizontal linear diffusion coefficient of the sample under the object plane grating coordinate, a three-dimensional reconstruction formula of the horizontal linear diffusion coefficient being
$$\begin{matrix}{ω}_{{x}^{′′}} ( {x}^{′} , {y}^{′} , {z}^{′} ) = {ℛ}^{- 1} [ {σ}_{{x}^{′′}}^{2} ( x , y , φ ) ] \\ = {\int }_{0}^{π} d φ {\int }_{- ∞}^{∞} {ℱ}_{x}^{- 1} \frac{\vert ρ \vert}{2 π i ρ} {ℱ}_{x} [ {σ}_{{x}^{′′}}^{2} ( x , y , φ ) ] \\ \hat{δ} ( {x}^{′} cos φ + {z}^{′} sin φ - x ) dx ;\end{matrix}$$
S35: reconstructing a vertical linear diffusion coefficient of the sample under the object plane grating coordinate, a three-dimensional reconstruction formula of the vertical linear diffusion coefficient being
$$\begin{matrix}{ω}_{{y}^{′′}} ( {x}^{′} , {y}^{′} , {z}^{′} ) = {ℛ}^{- 1} [ {σ}_{{y}^{′′}}^{2} ( x , y , φ ) ] \\ = {\int }_{π}^{2 π} d φ {\int }_{- ∞}^{∞} {ℱ}_{x}^{- 1} \frac{\vert ρ \vert}{2 π i ρ} {ℱ}_{x} [ {σ}_{{y}^{′′}}^{2} ( x , y , φ ) ] \\ \hat{δ} ( {x}^{′} cos φ + {z}^{′} sin φ - x ) dx ;\end{matrix}$$
wherein p is a period of the analysis grating, dₒ is an object distance of the sample relative to the objective lens, and dᵢ is an image distance of the imaging detector relative to the objective lens; Sₒ is an object distance of the grid-shaped structure relative to the objective lens, and Sᵢ is an image distance of the analysis grating relative to the objective lens; I₀ is an incident light intensity of the sample, Rₘₐₓ and Rₘᵢₙ are a maximum value and a minimum value of an angle signal response curve respectively, and I_{V}(X, Y, φ), I_{U}(X, Y, φ), I_{P}(X, Y, φ) and I_{D}(X, Y, φ) represent a valley amplified image, an ascending amplified image, a peak amplified image and a descending amplified image respectively.

2. The imaging method according to claim 1, wherein the annular inclined grid-shaped cone beam X-ray source is a monochromatic X-ray light source, and a middle part thereof has a light intensity of 0.

3. The imaging method according to claim 1, wherein a grating structure of the annular inclined grid-shaped cone beam X-ray source has a period of a micron order, and a grating inclination angle thereof is 0° to 90°.

4. The imaging method according to claim 1, wherein the sample table is located on the object plane, is configured to bear the sample, and can translate and rotate the sample.

5. The imaging method according to claim 1, wherein the objective lens is a zone plate or an optical element with an X-ray lens imaging function and is configured to amplify a sample structure with a nanoscale on the object plane into an image with a micron order structure on the image plane, and cause an annular part on the grid-shaped structure of the annular inclined grid-shaped cone beam X-ray source illuminated by a hollow cone beam to form an annular grating image and an annular grating image beam near a back focal plane of the objective lens.

6. The imaging method according to claim 1, wherein the analysis grating is an absorption grating with a period of a micron or submicron order, is located near the back focal plane of the objective lens, has a same shape and size as the annular grating image of the grid-shaped structure of the annular inclined grid-shaped cone beam X-ray source near the back focal plane of the objective lens, and is configured to filter the annular grating image beam near the back focal plane of the objective lens.

7. The imaging method according to claim 1, wherein the imaging detector is located on the image plane and configured to shoot a two-dimension amplified image of the sample.
